(19) United States
(12) Patent Application Publication
(10) Pub. No.: US 2008/0180379 A1
(43) Pub. Date: Jul. 31, 2008

(54) Liquid Crystal Display Device Capable of Reducing Irregularity in Brightness

(76) Inventor: Koji TAKAHASHI, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/929,691

(22) Filed: Oct. 30, 2007

(30) Foreign Application Priority Data
Jan. 31, 2007 (JP) 2007-21993

(51) Int. Cl. G09G 3/36

(52) U.S. Cl. 345/98

(57) ABSTRACT

In a liquid crystal display device, an electric charge is sent to an amplifying circuit from a power supply or an electric charge is returned to the power supply before a gradation voltage generating circuit is used. This makes a difference of an output voltage of the amplifying circuit and an ideal voltage become small. As a result, irregularity in brightness is reduced.

### CROSS-REFERENCE TO RELATED APPLICATIONS

This application is based upon and claims the benefit of priority from Japanese Patent Application No. 2007-021993 filed Jan. 31, 2007; the entire contents of which are incorporated herein by reference.

### BACKGROUND OF THE INVENTION

1. Field of the Invention

The present invention relates to a liquid crystal display device capable of reducing irregularity in brightness.

2. Description of the Related Art

FIG. 1 illustrates a partial block diagram of a liquid crystal display device of a prior art.

In the device, brightness of display elements B11, . . . B1n, G11, . . . G1n, R11, . . . R1n, B21, . . . B2n, G21, . . . G2n, R21, . . . R2n might become lower than brightness of display elements B31, . . . B3n, G31, . . . G3n, R31, . . . R3n, B41, . . . B4n, G41, . . . G4n, R41, . . . R4n. A stripe postponed to vertical scanning direction might be seen due to irregularity in brightness.

In FIG. 1, a brightness of a display element G11 is lower even if a maximum brightness is set in display elements G11 and G31. Similar phenomena happen in other display elements. They are recognized as the irregularity in brightness.

Ahead of describing a reason that the brightness of the display element G11 is low, an operation outline for setting a maximum brightness will be described.

FIG. 2 illustrates a partial block diagram of the device.

In a period when the brightness of the display element G11 is set, a signal processing circuit 51L sends a digital data to a digital-analog conversion circuit 41L′.

The digital-analog conversion circuit 41L′ selects one of analog switches SW01, SW01, . . . SW64 corresponding to the digital data. The digital-analog conversion circuit 41L′ selects the analog switch SW01 for example.

The digital-analog conversion circuit 41L′ connects circuit points in the selected analog switch with each other. The digital-analog conversion circuit 41L′ connects circuit points T01A and T01B with each other for example.

The digital-analog conversion circuit 41L′ lets circuit points in the other analog switches disconnected. The digital-analog conversion circuit 41L′ lets circuit points in the analog switch SW02 and the likes disconnected for example.

Only one circuit point of circuit point P1, P2, . . . P64 selected according to the digital data is connected to an input circuit point of an amplifying circuit 31L.

The amplifying circuit 31L having one or more capacitors sends an electric charge to the one or more capacitors from the selected circuit point or returns an electric charge from the one or more capacitors to the selected circuit point through the digital-analog conversion circuit 41L′.

A voltage of the input circuit point of the amplifying circuit 31L corresponds to a situation in an arrangement of an electric charge in the amplifying circuit 31L.

The amplifying circuit 31L amplifies the voltage and outputs an amplified voltage to its output circuit point.

A selecting circuit 21L connects circuit points TC and TG1 in an analog switch SWA with each other. The amplified voltage is provided to a signal line XG1.

Thus, the brightness of the display element G11 corresponds to the digital data.

Next, the reason that the brightness of the display element G11 is low will be described.

FIG. 3 illustrates a change in the voltage at the output circuit point of the amplifying circuit 31L.

In a period TB31, the circuit point P64 is selected for example. The output circuit point of the amplifying circuit 31L presents an output voltage. A brightness of the display element B31 is set by the voltage.

In a next period TG11, the circuit point P1 is selected for example. The output circuit point of the amplifying circuit 31L presents an output voltage. A brightness of the display element G11 is set by the voltage.

If the voltage reaches a voltage Vmax, the brightness is in maximum.

Since the circuit point P64 was selected in the previous period TB31, an amount of an electric charge passing through the input circuit point of the amplifying circuit 31L is large and a difference of the output voltage and the voltage Vmax is large.

In a next period TG31, the circuit point P1 is selected for example. The output circuit point of the amplifying circuit 31L presents an output voltage. A brightness of the display element G31 is set by the voltage.

If the voltage reaches the voltage Vmax, the brightness is in maximum.

Since the circuit point P1 was selected in the previous period TG11, the amount of an electric charge passing through the input circuit point of the amplifying circuit 31L is small and the difference of the output voltage and the voltage Vmax is small.

In a next period TR11, the circuit point P64 is selected for example. The output circuit point of the amplifying circuit 31L presents an output voltage. A brightness of the display element R11 is set by the voltage.

As mentioned, the brightness of display element G11 is low since the difference in the period TG11 is large.

A length of a period such as the period TG11 is short because the signal lines are selected sequentially. This also makes the difference larger.

A circuit such as the digital-analog conversion circuit 41L′ is called RDAC. A digital-analog conversion circuit configured to use capacitors is called CDAC. A situation in an arrangement of an electric charge in CDAC changes as well as in the amplifying circuit 31L. This also causes irregularity in brightness.

### SUMMARY OF THE INVENTION

A liquid crystal display device according to a first aspect of the present invention is characterized by including: a display unit having display elements; signal lines connected to the display elements; a gradation voltage generating circuit having a ladder resistor and configured to cause each of circuit points in the ladder resistor a voltage; a digital-analog conversion circuit configured to select one of the circuit points presenting a voltage corresponding to a digital data for setting a brightness in a corresponding one of the display elements; an amplifying circuit having one or more capacitors and configured to send an electric charge to the one or more capacitors from the selected circuit point or return an electric charge from the one or more capacitors to the selected circuit point; a voltage providing circuit configured to provide a voltage amplified by the amplifying circuit to a corresponding one of the signal lines; a power supply that outputs a voltage between a maximum voltage and a minimum voltage presented by the circuit points; and a circuit used to send an electric charge to the one or more capacitors from the power supply or return an electric charge from the one or more capacitors to the power supply before the selected circuit point is used.

In the first aspect of the present invention, it is assumed that a circuit point presenting a voltage higher than the voltage of the power supply is selected and then a circuit point presenting a voltage lower than the voltage of the power supply is selected.

Firstly, a situation in an arrangement of an electric charge in the amplifying circuit realized using the circuit point presenting the higher voltage changes to a situation realized using the power supply. This period is hereinafter referred to as “a return period”.

Then, the circuit point presenting the lower voltage is selected.

The return period can be short since the electric charge arrangement using the power supply does not need the ladder resistor and does not cause a voltage decent in the ladder resistor due to its resistance.

Because of the short return period, a length of time needed to realize a situation in an arrangement of an electric charge in the amplifying circuit corresponding to the digital data might be short.

This makes a difference of the output voltage of the amplifying circuit and an ideal voltage become small. And a brightness of a display element becomes near an ideal brightness. As a result, irregularity in brightness is reduced.

A liquid crystal display device according to a second aspect of the present invention is characterized by including: a display unit having display elements; signal lines connected to the display elements; a gradation voltage generating circuit having a ladder resistor and configured to cause each of circuit points in the ladder resistor a voltage; a high bits converter configured to select two of the circuit points presenting voltages which are equal to both ends of a voltage range corresponding to high bits of a digital data for setting a brightness in a corresponding one of the display elements; a low bits converter having capacitors and configured to send an electric charge to the capacitors from the two circuit points or return an electric charge from the capacitors toward the two circuit points and to move an electric charge among the capacitors according to low bits of the digital data to make a voltage of an electrode of one of the capacitors corresponding to the digital data; an amplifying circuit configured to amplify the voltage of the electrode; a voltage providing circuit configured to provide a voltage amplified by the amplifying circuit to a corresponding one of the signal lines; a power supply that outputs a voltage between a maximum voltage and a minimum voltage presented by the circuit points; and a circuit used to send an electric charge to the capacitors from the power supply or return an electric charge from the capacitors to the power supply before the selected circuit point is used.

In the second aspect of the present invention, it is assumed that circuit points presenting voltages higher than the voltage of the power supply and then circuit points presenting voltages lower than the voltage of the power supply.

Firstly, a situation in an arrangement of an electric charge in the low bits converter realized using the circuit points presenting the higher voltages changes to a situation realized using the power supply. This period is hereinafter referred to as “a return period”.

Then, the circuit points presenting the lower voltages are selected.

The return period can be short since an electric charge arrangement using the power supply does not need the ladder resistor and does not cause a voltage decent in the ladder resistor due to its resistance.

Because of the short return period, a length of time needed to realize a situation in an arrangement of an electric charge in the low bits converter corresponding to high bits of the digital data might be short.

This makes a difference of the output voltage of the amplifying circuit and an ideal voltage become small. And a brightness of a display element becomes near an ideal brightness. As a result, irregularity in brightness is reduced.

A liquid crystal display device according to a third aspect of the present invention is characterized in that the voltage providing circuit selects signal lines one by one in each group made as a result of dividing the signal lines into groups and then provides the selected line a voltage obtained according to a digital data for setting a brightness in a display element connected to the selected line. Others are same as those of the first or second aspect of the present invention.

In the third aspect of the present invention, a length of a period for setting a brightness in a display element is short and a difference of the output voltage of the amplifying circuit and the ideal voltage is likely to be large. However, an actual difference is small and the brightness becomes near the ideal brightness.

As a result, even in a situation that irregularity in brightness is likely to happen, the device can make it difficult to happen.

### BRIEF DESCRIPTION OF THE DRAWINGS

FIG. 1 illustrates the partial block diagram of the liquid crystal display device of the prior art;

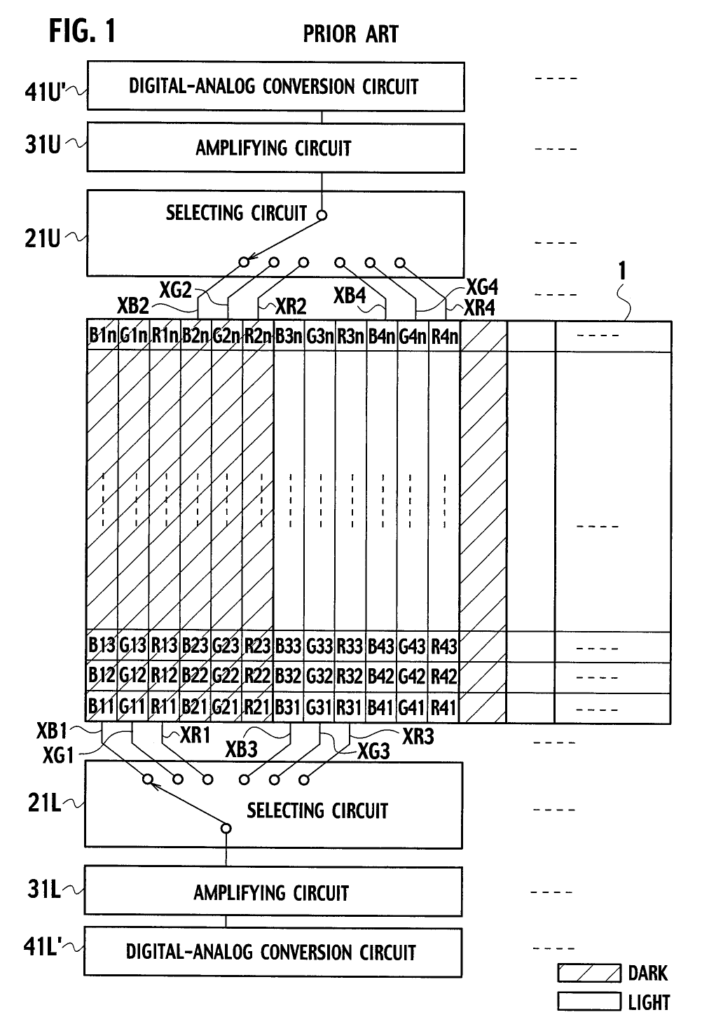

FIG. 2 illustrates the partial block diagram of the device;

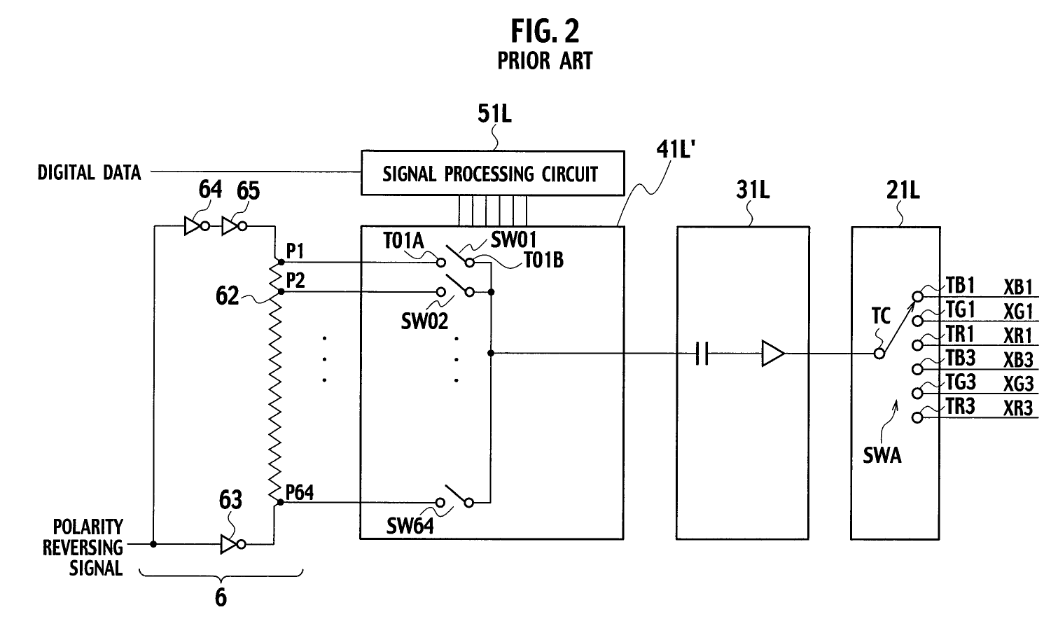

FIG. 3 illustrates the change in the voltage at the output circuit point of the amplifying circuit 31L;

FIG. 4 illustrates a partial block diagram of a liquid crystal display device according to a first embodiment of a present invention;

FIG. 5 illustrates a gradation voltage generating circuit 6, a selecting circuit 21L, an amplifying circuit 31L, a digital-analog conversion circuit 41L and a signal processing circuit 51L all configured in the device;

FIG. 6 illustrates a change in a voltage at an output circuit point of the amplifying circuit 31L;

FIG. 7 illustrates a gradation voltage generating circuit 6, a selecting circuit 21L, an amplifying circuit 31L, a digital-analog conversion circuit 41L and a signal processing circuit 51L all configured in a liquid crystal display device according to a second embodiment of the present invention;

### DESCRIPTION OF THE EMBODIMENT

### First Embodiment

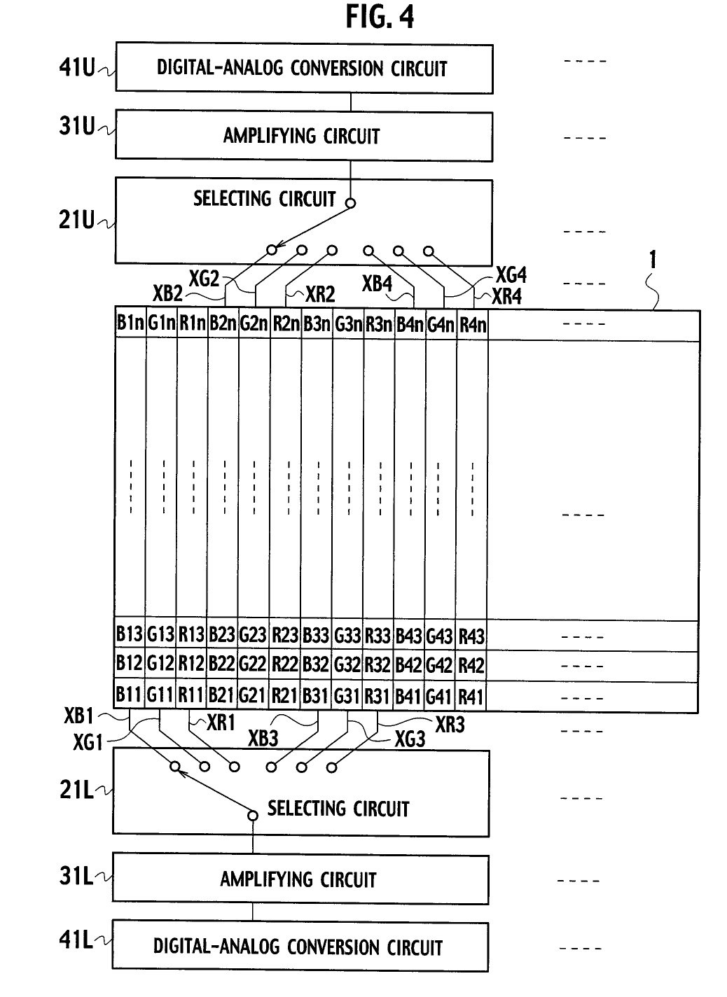

As illustrated in FIG. 4, the liquid crystal display device according to the first embodiment has a display unit 1 configured by a display element B11 and the likes, a signal line XB1 connected to display elements B11, . . . B1n and the likes, a selecting circuit 21L connected to signal lines XB1, XG1, XR1, XB3, XG3 and XR3 and the likes, an amplifying circuit 31L connected to the selecting circuit 21L and the likes, a digital-analog conversion circuit 41L connected to the amplifying circuit 31L and the likes.

The selecting circuit 21L in FIG. 4 provides voltages to the signal lines and can be called a voltage providing circuit.

The signal lines are divided into groups. For example, one of the groups consists of the signal lines XB1, XG1, XR1, XB3, XG3 and XR3. For setting brightness in display elements connected to the signal lines, the selecting circuit 21L, the amplifying circuit 31L and the digital-analog conversion circuit 41L are used.

For setting brightness in display elements connected to the signal lines XB2, XG2, XR2, XB4, XG4 and XR4, a selecting circuit 21U, an amplifying circuit 31U and a digital-analog conversion circuit 41U are used.

For setting brightness in display elements connected to signal lines in another group, a selecting circuit, an amplifying circuit and a digital-analog conversion circuit configured for the group.

The selecting circuits, the amplifying circuits and the digital-analog conversion circuits are divided into two groups. A letter U in reference marks specifies circuits in one of the group. A letter L in reference marks specifies circuits in the other group. The display unit 1 is located between the groups.

Although not illustrated, the device has scanning lines connected to the display elements B11, G11, R11, . . . and a scanning circuit connected to the scanning lines.

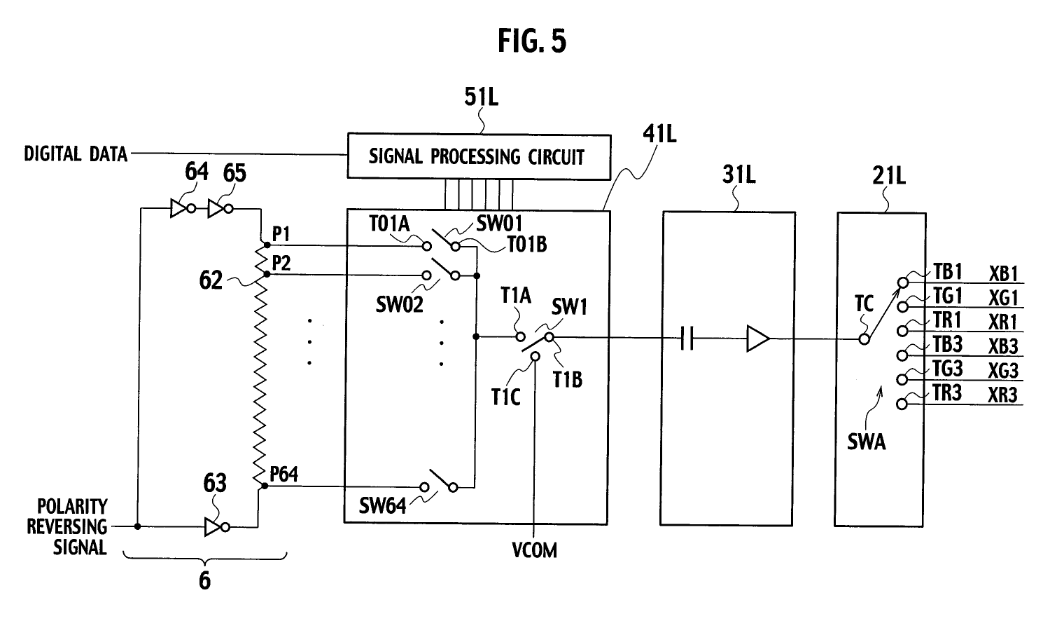

As illustrated in FIG. 5, a signal processing circuit 51L and a gradation voltage generating circuit 6 are connected to the digital-analog conversion circuit 41L.

The gradation voltage generating circuit 6 has a ladder resistor 62, signal reversing circuits 63, 64 and 65. An output circuit point of the signal reversing circuit 63 is connected to one end point of the ladder resistor 62. The signal reversing circuit 64 and 65 are connected each other in series. An output circuit point of the signal reversing circuit 65 is connected to the other end point of the ladder resistor 62. The ladder resistor 62 has circuit points P1, . . . P64.

The digital-analog conversion circuit 41L has analog switches SW01, . . . SW64 and SW1.

A circuit point T01A in the analog switch SW01 is connected to the circuit point P1. The analog switches SW02, . . . SW64 are connected to the circuit points P2, . . . P64 likewise.

A circuit point T01B in the analog switch SW01 is connected to a circuit point T1A in the analog switch SW1. The analog switches SW02, . . . SW64 are connected to the circuit point T1A likewise.

A circuit point T1B in the analog switch SW1 is connected to an input circuit point of the amplifying circuit 31L.

A power supply VCOM is used in the embodiment. The power supply VCOM outputs a voltage between a maximum voltage and a minimum voltage presented by the circuit points P1, . . . P64. The voltage of the power supply is used for setting a minimum brightness in a display element.

A circuit point T1C in the analog switch SW1 is connected to the power supply VCOM.

The selecting circuit 21L has an analog switch SWA. The analog switch SWA has circuit points TB1, TG1, TR1, TB3, TG3, TR3 and TC. The circuit points TB1, TG1, TR1, TB3, TG3 and TR3 are connected to the signal lines XB1, XG1, XR1, XB3, XG3 and XR3 respectively. The circuit point TC is connected to an output circuit point of the amplifying circuit 31L.

### Operations of the Device According to the First Embodiment

Next, operations of the device will be described.

For example, a digital data is sent to the signal processing circuit 51L in FIG. 5. The digital data is one for setting a brightness in the display element G11 in FIG. 4. The digital data is sent from a control device not illustrated.

A brightness of a display element corresponds to a voltage of a signal line connected to the display element. Therefore such digital data corresponds to the voltage.

The digital data consists of 6 bits and expresses 64 steps of brightness for example.

In a frame period, a polarity reversing signal presenting a high level is inputted to the input circuit points of the signal reversing circuits 63 and 64. The circuit point P1 presents a maximum voltage among the circuit points P1, . . . P64. The nearer the circuit point P64 another circuit point is, the lower a voltage of the circuit point is.

In a period when the brightness of the display element G11 is set, the signal processing circuit 51L sends the digital data to the digital-analog conversion circuit 41L.

The digital-analog conversion circuit 41L firstly connects the circuit points T1B and T1C in the analog switch SW1 with each other. The digital-analog conversion circuit 41L lets the circuit point T1A disconnected.

The power supply VCOM is connected to the input circuit point of the amplifying circuit 31L through the analog switch SW1.

The amplifying circuit 31L having one or more capacitors sends an electric charge to the one or more capacitors from the power supply VCOM or returns an electric charge from the one or more capacitors to the power supply VCOM through the digital-analog conversion circuit 41L.

The electric charge arrangement using the power supply VCOM can be done in a short time since it does not cause a voltage decent in the ladder resistor 62 due to its resistance.

A length of a period when the electric charge arrangement using the power supply VCOM is done is predetermined. The period ends when the length passed.

The digital-analog conversion circuit 41L connects the circuit points T1A and T1B in the analog switch SW1 with each other. The digital-analog conversion circuit 41L lets the circuit point TIC disconnected.

The digital-analog conversion circuit 41L selects one of analog switches SW01, SW01, . . . SW64 corresponding to the digital data. The digital-analog conversion circuit 41L selects an analog switch SW01 for example.

The digital-analog conversion circuit 41L connects circuit points in the selected analog switch with each other. The digital-analog conversion circuit 41L connects circuit points T01A and T01B with each other for example.

The digital-analog conversion circuit 41L lets circuit points in the other analog switches disconnected. The digital-analog conversion circuit 41L lets circuit points in the analog switch SW02 and the likes disconnected for example.

Only one circuit point of the circuit points P1, P2, . . . P64 selected according to the digital data is connected to the input circuit point of the amplifying circuit 31L.

The amplifying circuit 31L having the one or more capacitors sends an electric charge to the one or more capacitors from the selected circuit point or returns an electric charge from the one or more capacitors to the selected circuit point through the digital-analog conversion circuit 41L.

Thus, a situation in an arrangement of an electric charge in the amplifying circuit 31L corresponds to the digital data.

Since the electric charge arrangement using the power supply VCOM is done, a length of time needed to realize the situation might be short.

A reason will be described.

It is assumed that the circuit point P64 is selected and then the circuit point P1 is selected.

Firstly, a situation in an arrangement of an electric charge in the amplifying circuit 31L realized using the circuit point P64 changes to a situation realized using the power supply VCOM. This period is hereinafter referred to as “a return period”.

Then, the circuit point P1 is selected.

The return period can be short since the electric charge arrangement using the power supply VCOM does not need the ladder resistor 62 and does not cause a voltage decent in the ladder resistor 62 due to its resistance.

Because of the short return period, a length of time needed to realize a situation in an arrangement of an electric charge in the amplifying circuit 31L corresponding to the digital data might be short.

At the time, a voltage of the input circuit point of the amplifying circuit 31L corresponds to a situation in an arrangement of an electric charge in the amplifying circuit 31L.

The amplifying circuit 31L amplifies the voltage and outputs an amplified voltage to its output circuit point.

The selecting circuit 21L connects circuit points TC and TG1 in the analog switch SWA with each other and lets the other circuit points in the analog switch SWA disconnected. The amplified voltage is provided to the signal line XG1.

Thus, the brightness of the display element G11 corresponds to the digital data.

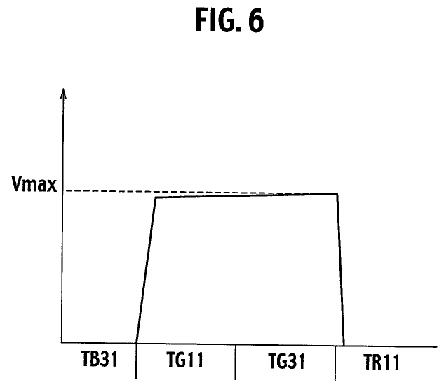

In FIG. 6, firstly in a period TB31, the circuit point P64 is selected for example. The output circuit point of the amplifying circuit 31L presents an output voltage. A brightness of the display element B31 is set by the voltage.

In a next period TG11, the circuit point P1 is selected for example.

The output circuit point of the amplifying circuit 31L presents an output voltage. A brightness of the display element G11 is set by the voltage.

If the voltage reaches a voltage Vmax, the brightness is in maximum.

Since the circuit point P64 was selected in the previous period TB31, an amount of an electric charge passing through the input circuit point of the amplifying circuit 31L is large.

Without the electric charge arrangement using the power supply VCOM, a voltage decent in the ladder resistor 62 due to its resistance is caused and a difference of the output voltage and the voltage Vmax is large.

However, since the electric charge arrangement using the power supply VCOM is done, a voltage decent in the ladder resistor 62 due to its resistance is not caused and a length of time till an end of the electric charge arrangement is short.

Thus, a difference of the output voltage and the voltage Vmax is reduced in a short time. That is, a voltage of the output circuit point of the amplifying circuit 31L approaches the voltage Vmax in a short time.

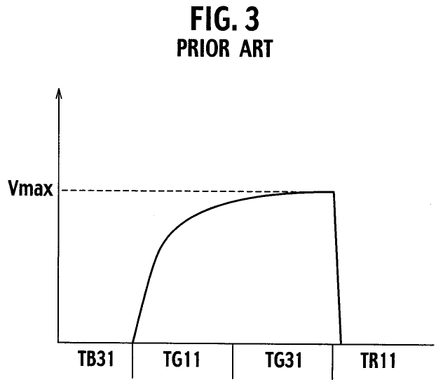

In FIG. 6, the output voltage does not reach the voltage Vmax, but there is an improvement compared to the case in FIG. 3 that the electric charge arrangement using the power supply VCOM is not done.

Thus, the difference of the brightness of the display element G11 and the maximum brightness is smaller than one in a case that the electric charge arrangement using the power supply VCOM is not done.

In a next period TG31, the circuit point P1 is selected for example. The output circuit point of the amplifying circuit 31L presents an output voltage. A brightness of the display element G31 is set by the voltage.

If the voltage reaches the voltage Vmax, the brightness is in maximum.

Since the circuit point P1 was selected in the previous period TG11, an amount of an electric charge passing through the input circuit point of the amplifying circuit 31L is small and a difference of the output voltage and the voltage Vmax is small.

In a next period TR11, the circuit point P64 is selected for example. The output circuit point of the amplifying circuit 31L presents an output voltage. A brightness of the display element R11 is set by the voltage.

Thus, signal lines in each group of the signal lines are selected one by one, voltages obtained according to digital data for setting brightness in display elements connected to the selected signal line are provided to the selected signal line, and brightness in the display elements are set.

And since the difference of the output voltage and the voltage Vmax in the period TG11 is small as well as one in the period TG31, the brightness of the display element G11 can be larger to become near the brightness of the display element G31.

Likewise, the brightness of display elements B11, . . . B1n, G11, . . . G1n, R11, . . . R1n, B21, . . . B2n, G21, . . . G2n, R21, . . . R2n can be larger to become near the brightness of display elements B31, . . . B3n, G31, . . . G3n, R31, . . . R3n, B41, . . . B4n, G41, . . . G4n, R41, . . . R4n.

As a result, the device can prevent a stripe postponed to vertical scanning direction due to irregularity in brightness to be seen.

The device selects signal lines in each group of the signal lines one by one, and provides voltages obtained according to digital data for setting brightness in display elements connected to the selected signal line. Therefore, a length of a period for setting a brightness in a display element is short and a difference of the output voltage of the amplifying circuit 31L and the voltage Vmax is likely to be large. However, an actual difference is small and the brightness becomes near the ideal brightness. As a result, even in a situation that irregularity in brightness is likely to happen, the device can make it difficult to happen.

### Second Embodiment

Since a liquid crystal display device according to a second embodiment is configured as illustrated in FIG. 4, a description of FIG. 4 will be omitted.

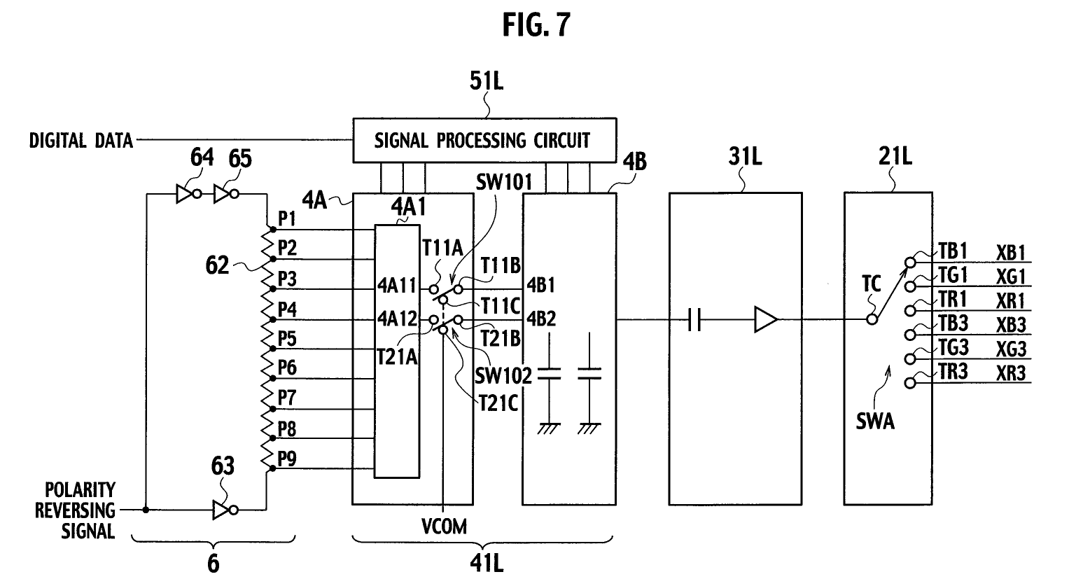

Although the gradation voltage generating circuit 6 and the digital-analog conversion circuit 41L in FIG. 7 are different from ones illustrated in FIG. 4, the same reference marks are expediently used.

In the second embodiment, same components also used in the device according to the first embodiment and similar components will expediently be described using the same reference marks.

The gradation voltage generating circuit 6 has a ladder resistor 62, signal reversing circuits 63, 64 and 65. An output circuit point of the signal reversing circuit 63 is connected to one end point of the ladder resistor 62. The signal reversing circuit 64 and 65 are connected each other in series. An output circuit point of the signal reversing circuit 65 is connected to the other end point of the ladder resistor 62. The ladder resistor 62 has circuit points P1, . . . P9.

The digital-analog conversion circuit 41L has a high bits converter 4A configured to operate using high bits of digital data to be sent from the signal processing circuit 51L and a low bits converter 4B configured to operate using low bits of digital data to be sent from the signal processing circuit 51L.

The high bits converter 4A has a circuit 4A1, analog switches SW101 and SW102. The circuit 4A1 has output circuit points 4A11 and 4A12 and is configured to select two of the circuit points P1, . . . P9 and connects the selected circuit points to the output points 4A11 and 4A12.

A circuit point T11A in the analog switch SW101 is connected to the output circuit point 4A11 of the circuit 4A.

A circuit point T21A in the analog switch SW102 is connected to the output circuit point 4A12 of the circuit 4A.

Both of a circuit point T11C in the analog switch SW101 and a circuit point T21C in the analog switch SW102 are connected to the power supply VCOM.

The low bits converter 4B has input circuit points 4B1, 4B2 and capacitors.

### Operations of the Device According to the Second Embodiment

Next, operations of the device will be described.

For example, a digital data is sent to the signal processing circuit 51L in FIG. 7. The digital data is one for setting a brightness in the display element G11 in FIG. 4. The digital data is sent from a control device not illustrated.

A brightness of a display element corresponds to a voltage of a signal line connected to the display element. Therefore such digital data corresponds to the voltage.

The digital data consists of 6 bits and expresses 64 steps of brightness for example.

High bits of a digital data correspond to a voltage range of a signal line since the digital data is for setting a voltage of a signal line. The circuit points P1, . . . P9 are set in order that one of them presents one end voltage of the range and the next circuit point presents the other end of the range.

In a frame period, a polarity reversing signal presenting a high level is inputted to the input circuit points of the signal reversing circuits 63 and 64. The circuit point P1 presents a maximum voltage among the circuit points P1, . . . P9. The nearer the circuit point P9 another circuit point is, the lower a voltage of the circuit point is.

In a period when the brightness of the display element G11 is set, the signal processing circuit 51L sends high bits of the digital data to the high bits converter 4A and sends low bits of the digital data to the low bits converter 4B.

The high bits converter 4A firstly connects the circuit points T11B and T11C in the analog switch SW101 with each other. The high bits converter 4A lets the circuit point T11A disconnected.

The high bits converter 4A connects the circuit points T21B and T21C in the analog switch SW102 with each other. The high bits converter 4A lets the circuit point T21A disconnected.

The power supply VCOM is connected to the input circuit points 4B1 and 4B2 of the low bits converter 4B through the analog switches SW101 and SW102.

The low bits converter 4B sends an electric charge to the capacitors in itself from the power supply VCOM or returns an electric charge from the capacitors to the power supply VCOM through the high bits converter 4A.

The electric charge arrangement using the power supply VCOM can be done in a short time since it does not cause a voltage decent in the ladder resistor 62 due to its resistance.

A length of a period when the electric charge arrangement using the power supply VCOM is done is predetermined. The period ends when the length passed.

The high bits converter 4A connects the circuit points T11A and T11B in the analog switch SW101 with each other. The high bits converter 4A lets the circuit point T11C disconnected.

The high bits converter 4A connects the circuit points T21A and T21B in the analog switch SW102 with each other. The high bits converter 4A lets the circuit point T21C disconnected.

The circuit 4A1 in the high bits converter 4A selects two of the circuit points P1, . . . P9 presenting voltages which are equal to both ends of a voltage range corresponding to 3 high bits of the digital data and connects them to the output circuit points 4A11 and 4A12. The circuit 4A1 connects the circuit points P1 and P2 to the output circuit points 4A11 and 4A12 respectively for example.

The two circuit points are connected to the input circuit points 4B1 and 4B2 of the low bits converter 4B through the analog switches SW101 and SW102.

The low bits converter 4B having capacitors sends an electric charge to the capacitors from the two circuit points or returns an electric charge from the capacitors to the two circuit points through the high bits converter 4A.

Thus, a situation in an arrangement of an electric charge in the low bits converter 4B corresponds to the 3 high bits of the digital data.

Since the electric charge arrangement using the power supply VCOM is done, a length of time needed to realize the situation might be short.

A reason will be described.

It is assumed that the circuit points P8 and P9 are selected and then the circuit points P1 and P2 are selected.

Firstly, a situation in an arrangement of an electric charge in the low bits converter 4B realized using the circuit point P8 and P9 changes to a situation realized using the power supply VCOM. This period is hereinafter referred to as “a return period” as well as in the first embodiment.

Then, the circuit points P1 and P2 are selected.

The return period can be short since an electric charge arrangement using the power supply VCOM does not need the ladder resistor 62 and does not cause a voltage decent in the ladder resistor 62 due to its resistance.

Because of the short return period, a length of time needed to realize a situation in an arrangement of an electric charge in the low bits converter 4B corresponding to the high bits of the digital data might be short.

The low bits converter 4B moves an electric charge among the capacitors according to the 3 low bits of the digital data. As a result, a voltage of a predetermined electrode of the capacitors corresponds to the digital data. The electrode is hereinafter referred to as “an electrode Pc”.

The low bits converter 4B connects the electrode Pc to the input circuit point of the amplifying circuit 31L.

Thus, the digital-analog conversion circuit 41L converts the digital data to a voltage having a magnitude corresponding to the digital data and provides the voltage to the amplifying circuit 31L.

The amplifying circuit 31L amplifies a voltage of its input circuit point connected to the electrode Pc and outputs an amplified voltage to its output circuit point.

The selecting circuit 21L connects circuit points TC and TG1 in the analog switch SWA with each other and lets the other circuit points in the analog switch SWA disconnected. The amplified voltage is provided to the signal line XG1.

Thus, the brightness of the display element G11 corresponds to the digital data.

In FIG. 6, firstly in a period TB31, the circuit points P8 and P9 are selected for example. The output circuit point of the amplifying circuit 31L presents an output voltage. A brightness of the display element B31 is set by the voltage.

In a next period TG11, the circuit points P1 and P2 are selected for example. The output circuit point of the amplifying circuit 31L presents an output voltage. A brightness of the display element G11 is set by the voltage.

If the voltage reaches a voltage Vmax, the brightness is in maximum.

Since the circuit points P8 and P9 were selected in the previous period TB31, an amount of an electric charge passing through the input circuit points of the low bits converter 4B is large.

Without the electric charge arrangement using the power supply VCOM, a voltage decent in the ladder resistor 62 due to its resistance is caused and a difference of the output voltage and the voltage Vmax is large.

However, since the electric charge arrangement using the power supply VCOM is done, a voltage decent in the ladder resistor 62 due to its resistance is not caused and a length of time till an end of the electric charge arrangement is short.

Thus, a difference of the output voltage and the voltage Vmax is reduced in a short time. That is, a voltage of the output circuit point of the amplifying circuit 31L approaches the voltage Vmax in a short time.

Thus, the difference of the brightness of the display element G11 and the maximum brightness is smaller than one in a case that the electric charge arrangement using the power supply VCOM is not done.

In a next period TG31, the circuit points P1 and P2 are selected for example. The output circuit point of the amplifying circuit 31L presents an output voltage. A brightness of the display element G31 is set by the voltage.

If the voltage reaches the voltage Vmax, the brightness is in maximum.

Since the circuit points P1 and P2 were selected in the previous period TG11, an amount of an electric charge passing through the input circuit points of the low bits converter 4B is small and a difference of the output voltage and the voltage Vmax is small.

In a next period TR11, the circuit points P8 and P9 are selected for example. The output circuit point of the amplifying circuit 31L presents an output voltage. A brightness of the display element R11 is set by the voltage.

Thus, signal lines in each group of the signal lines are selected one by one, voltages obtained according to digital data for setting brightness in display elements connected to the selected signal line are provided to the selected signal line, and brightness in the display elements are set.

And since the difference of the output voltage and the voltage Vmax in the period TG11 is small as well as one in the period TG31, the brightness of the display element G11 can be larger to become near the brightness of the display element G31.

Likewise, the brightness of display elements B11, . . . B1n, G11, . . . G1n, R11, . . . R1n, B21, . . . B2n, G21, . . . G2n, R21, . . . R2n can be larger to become near the brightness of display elements B31, . . . B3n, G31, . . . G3n, R31, . . . R3n, B41, . . . B4n, G41, . . . G4n, R41, . . . R4n.

As a result, the device can prevent a stripe postponed to vertical scanning direction due to irregularity in brightness to be seen.

As well as in the device according to the first embodiment, a length of a period for setting a brightness in a display element is short and a difference of the output voltage of the amplifying circuit 31L and the voltage Vmax is likely to be large. However, an actual difference is small and the brightness becomes near the ideal brightness. As a result, even in a situation that irregularity in brightness is likely to happen, the device can make it difficult to happen.

Both the device according to the first embodiment and the device according to the second embodiment set a brightness in each display element by the digital-analog conversion circuits on a number that is less than the number of the signal lines because the devices use the selecting circuits.

However, the devices may eliminate the selecting circuits and do the setting by the digital-analog conversion circuits on a number that is equal to the number of the signal lines.

In the devices, the digital data consists of 6 bits. However, the number is not limited to 6.

The ladder resistor in the first embodiment has 64 circuit points. The ladder resistor in the second embodiment has 9 circuit points. However, there is no limitation in the number.

In the devices, the digital-analog conversion circuits and the likes are separated by the display unit. However, they may be arranged in one side of the display unit.

In the devices, the level of the polarity reversing signal that is inputted to the input circuit point of the signal reversing circuits 63 and 64 reverses every frame period. However, the level may reverse every horizontal scanning period.

The devices may eliminate both the polarity reversing signal and the signal reversing circuits and let voltages at both ends of the ladder resistor be constant.

What is claimed is:

1. A liquid crystal display device comprising:
a display unit having display elements;
signal lines connected to the display elements;
a gradation voltage generating circuit having a ladder resistor and configured to cause each of circuit points in the ladder resistor a voltage;
a digital-analog conversion circuit configured to select one of the circuit points presenting a voltage corresponding to a digital data for setting a brightness in a corresponding one of the display elements;
an amplifying circuit having one or more capacitors and configured to send an electric charge to the one or more capacitors from the selected circuit point or return an electric charge from the one or more capacitors to the selected circuit point;
a voltage providing circuit configured to provide a voltage amplified by the amplifying circuit to a corresponding one of the signal lines;
a power supply that outputs a voltage between a maximum voltage and a minimum voltage presented by the circuit points; and
a circuit used to send an electric charge to the one or more capacitors from the power supply or return an electric charge from the one or more capacitors to the power supply before the selected circuit point is used.

2. A liquid crystal display device comprising:
a display unit having display elements;
signal lines connected to the display elements;
a gradation voltage generating circuit having a ladder resistor and configured to cause each of circuit points in the ladder resistor a voltage;
a high bits converter configured to select two of the circuit points presenting voltages which are equal to both ends of a voltage range corresponding to high bits of a digital data for setting a brightness in a corresponding one of the display elements;
a low bits converter having capacitors and configured to send an electric charge to the capacitors from the two circuit points or return an electric charge from the capacitors toward the two circuit points and to move an electric charge among the capacitors according to low bits of the digital data to make a voltage of an electrode of one of the capacitors corresponding to the digital data;
an amplifying circuit configured to amplify the voltage of the electrode;
a voltage providing circuit configured to provide a voltage amplified by the amplifying circuit to a corresponding one of the signal lines;
a power supply that outputs a voltage between a maximum voltage and a minimum voltage presented by the circuit points; and
a circuit used to send an electric charge to the capacitors from the power supply or return an electric charge from the capacitors to the power supply before the selected circuit point is used.

3. The liquid crystal display device according to claim 1 or claim 2, wherein the voltage providing circuit selects signal lines one by one in each group made as a result of dividing the signal lines into groups and then provides the selected line a voltage obtained according to a digital data for setting a brightness in a display element connected to the selected line.
